(19) United States
(12) Patent Application Publication
(10) Pub. No.: US 2025/0251079 A1
(43) Pub. Date: Aug. 7, 2025

(54) ANGLE-ADJUSTABLE FIXING STRUCTURE

(71) Applicant: ABILITY ENTERPRISE CO., LTD., New Taipei City (TW)

(72) Inventors: Che-Jen HSU, New Taipei City (TW); Cheng-Kuang TSENG, New Taipei City (TW); Yung-Tseng YEN, New Taipei City (TW); Chang-Hsiao CHI, New Taipei City (TW)

(21) Appl. No.: 19/034,665

(22) Filed: Jan. 23, 2025

(30) Foreign Application Priority Data
Feb. 1, 2024 (TW) 113201265

(51) Int. Cl. F16M 11/14; F16M 13/02; G03B 17/56

(52) U.S. Cl. CPC F16M 11/14; F16M 13/027; G03B 17/561

(57) ABSTRACT

An angle-adjustable fixing structure includes a body, a base, a pushing member, an adjustment member and a locking member. The body includes a first pivot portion. The base is on a side of the body. The pushing member is on the base. The pushing member includes a second pivot portion. The adjustment member includes an arc-shaped body disposed between the first pivot portion and the second pivot portion. The locking member passes through and is fixed to the body, and pushes against at least one of the base and the pushing member. The present invention can achieve all-round adjustment at any angle by adjusting the tightness of the arc-shaped body.

This application claims the benefit of Taiwan Application No. 113201265, filed Feb. 1, 2024, the subject matter of which is incorporated herein by reference.

### BACKGROUND OF THE INVENTION

### Field of the Invention

The invention relates in general to an angle-adjustable fixing structure, and more particularly to a fixing structure which is easy to adjust to any angle.

### Description of the Related Art

Many products in our daily lives utilize adjustable angle fixing structures to meet diverse usage requirements. For instance, cameras require different shooting angles based on their focal length, orientation, the structure of the object they are attached to, and the desired image composition. Therefore, cameras need to be mounted on a fixed object through an angle-adjustable fixing structure to allow for quick adjustments and meet user needs.

However, while adjusting the angle, the user often feels a lot of inconvenience due to complicated operation steps or the need to use multiple tools.

### SUMMARY OF THE INVENTION

In view of the shortcomings of the existing technology, the present invention provides an angle-adjustable fixing structure, and any angle can be adjusted by adjusting the tightness of an arc-shaped body.

In order to achieve the above purpose, the present invention provides an angle-adjustable fixing structure. The angle-adjustable fixing structure includes a body, a base, a pushing member, an adjustment member and a locking member. The body includes a first pivot portion. The base is in the body. The pushing member is on the base. The pushing member includes a second pivot portion. The adjustment member includes an arc-shaped body between the first pivot portion and the second pivot portion. The locking member is locked to the body and pushes against at least one of the base and the pushing member to tighten or relax the arc-shaped body.

According to an embodiment, an angle-adjustable fixing structure includes a body, a base, a pushing member, an adjustment member and a locking member. The body includes a first pivot portion. The base includes a first surface. The base is on a side of the body. The pushing member includes a second pivot portion and a second surface connecting to the first surface, and the pushing member is on the base. The adjustment member includes an arc-shaped body between the first pivot portion and the second pivot portion. The locking member includes an end. The locking member passes through the body, and the end is between the first surface and the second surface and is in the body.

According to an embodiment, an angle-adjustable fixing structure includes a body, a base, a pushing member, an adjustment member and a locking member. The body includes a first pivot portion and a slot. The base is on a side of the body. The pushing member is on the base. The pushing member includes a second pivot portion. The adjustment member is in the slot. The adjustment member includes an arc-shaped body between the first pivot portion and the second pivot portion. The locking member passes through the body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an exploded view of an angle-adjustable fixing structure according to an embodiment of the present invention.

FIG. 2 is a three-dimensional (3D) view of the fixing structure of FIG. 1.

FIG. 3 is a 3D view omitting the adjustment member in FIG. 2.

FIG. 4 is a schematic view of a first cover of the fixing structure of FIG. 1.

FIG. 5 is a schematic view of a second cover of the fixing structure of FIG. 1.

FIG. 6 is a 3D cross-sectional view of the fixing structure of FIG. 2.

FIG. 7 is a schematic cross-sectional view of the fixing structure of FIG. 2 taken along section line 7-7′, showing an arc-shaped body in a tight state.

FIG. 8 is a schematic cross-sectional view of the fixing structure, showing the arc-shaped body in a relaxed state.

FIG. 9 is a schematic 3D cross-sectional view of the fixing structure, showing the adjustment member in a second position.

### DETAILED DESCRIPTION OF THE INVENTION

Each embodiment of the present invention will be described in detail below, and the drawings will be used as illustrations. In addition to these detailed descriptions, the present invention can also be widely implemented in other embodiments. Easy substitutions, modifications, and equivalent changes of any of the embodiments are included in the scope of the present invention, and the scope of the present invention depends on the subsequent claims. In the description of the specification, many specific details and implementation examples are provided to enable readers to have a more complete understanding of the present invention; however, these specific details and implementation examples should not be regarded as limitations of the present invention. In addition, well-known steps or components are not described in detail to avoid unnecessary limitations of the present invention.

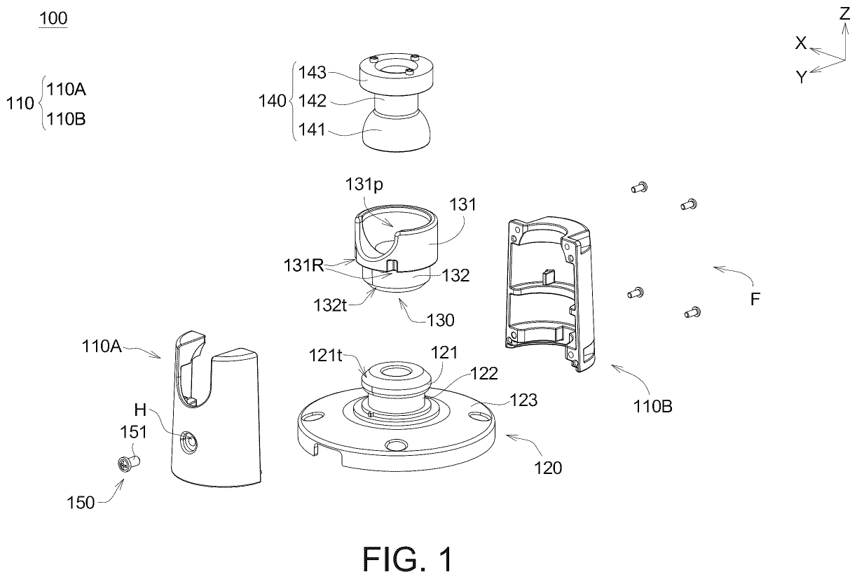

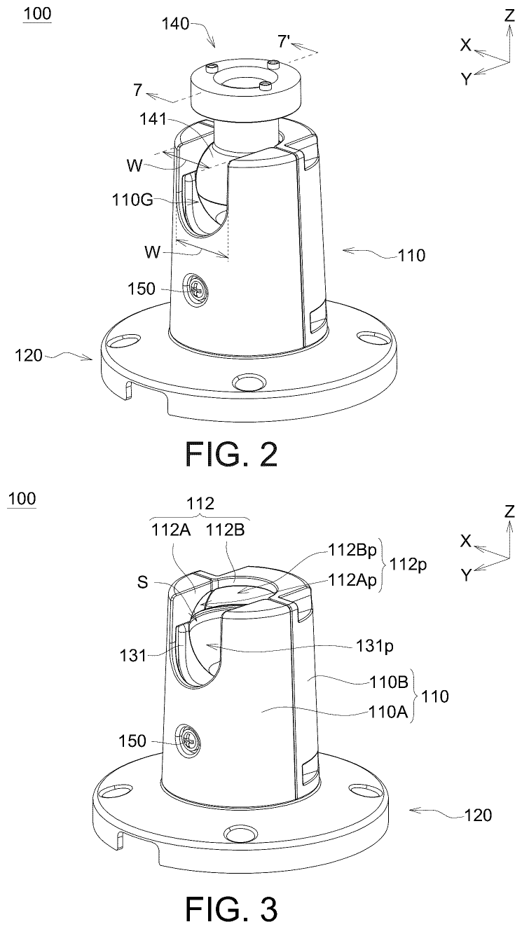

FIG. 1 is an exploded view of an angle-adjustable fixing structure 100 according to an embodiment of the present invention. FIG. 2 is a three-dimensional (3D) view of the fixing structure 100 of FIG. 1.

Please refer to FIGS. 1 and 2. The angle-adjustable fixing structure 100 at least includes a body 110, a base 120, a pushing member 130, an adjustment member 140 and a locking member 150. The body 110 has a tubular space, and the base 120 can be on a side of the body 110. The pushing member 130 is on the base 120 and is in the tubular space of the body 110. The adjustment member 140 is on the pushing member 130. The body 110 may include a first cover 110A and a second cover 110B. The first cover 110A and the second cover 110B combine together to form a tubular space of the body 110. The first cover 110A and the second cover 110B can be relatively fixed by screws F, and/or relatively buckled through structural design or adhesively fixed, and the present invention is not limited thereto.

The base 120 may include a protruding portion 121, a first shaft portion 122 and a first connecting portion 123. The first shaft portion 122 is on the first connecting portion 123, and the protruding portion 121 is on the first shaft portion 122. The adjustment member 140 may include an arc-shaped body 141, a second shaft portion 142 and a second connecting portion 143. The second shaft portion 142 connects to the arc-shaped body 141 and the second connecting portion 143. The base 120 and the adjustment member 140 can insert into the body 110. The first shaft portion 122 of the base 120 and the arc-shaped body 141 of the adjustment member 140 are in the tubular space of the body 110, and the first connecting portion 123 and the second connecting portion 143 respectively expose at both ends of the body 110. Therefore, if an independent first component (not shown) and an independent second component (not shown) are fixed to the first connecting portion 123 and the second connecting portion 143 respectively, the first component and the second component can connect through the fixing structure 100. On the other hand, the first component and the second component can also pivot relative to the body 110 through the base 120 and the adjustment member 140, and can be at a certain angle arbitrarily. For example, the first component can be a wall, a column, a ceiling or a large object, and the second component can be a camera device. The camera device can connect to the wall, column, ceiling or large object through the fixing structure 100 and the direction of the camera can change along with the user's requirements, but the present invention is not limited thereto.

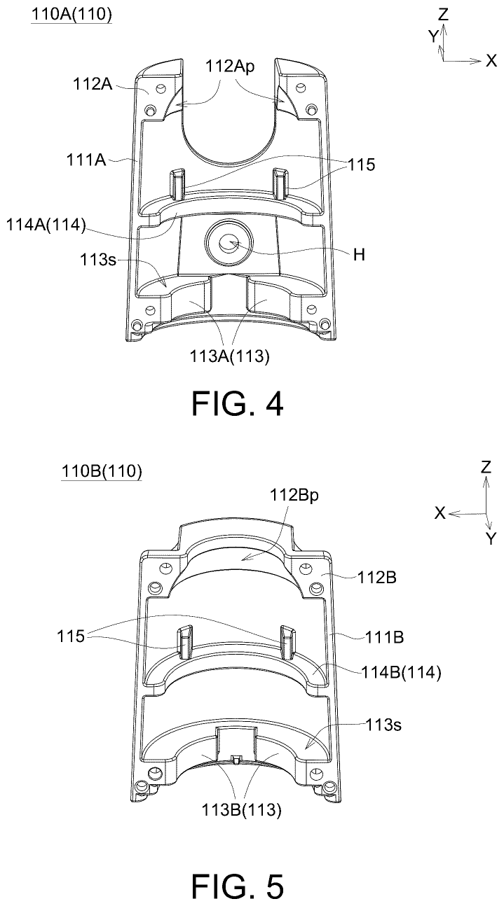

FIG. 3 is a perspective view omitting the adjustment member 140 in FIG. 2. FIG. 4 is a schematic view of the first cover 110A of the fixing structure 100 of FIG. 1. FIG. 5 is a schematic view of a second cover 110B of the fixing structure 100 of FIG. 1.

Please refer to FIGS. 3 to 5, the body 110 may include a first pivot portion 112 having a first pivot surface 112p. The first cover 110A may include a first cover body 111A and a first sub-pivot portion 112A. The first sub-pivot portion 112A is above the first cover body 111A (in the positive Z-axis direction), and the first sub-pivot portion 112A has an inner arc surface 112Ap; the second cover 110B may include a second cover body 111B and a second sub-pivot portion 112B. The second sub-pivot portion 112B is above the second cover body 111B (in the positive Z-axis direction), and the second sub-pivot portion 112B has a second inner arc surface 112Bp.

Please refer to FIGS. 3 to 5 again. While the first cover 110A and the second cover 110B are relatively fixed, the first sub-pivot portion 112A of the first cover 110A and the second sub-pivot portion 112B of the second cover 110B can connect to each other to form the first pivot 112 of the body 110. The first inner arc surface 112Ap of the first sub-pivot portion 112A and the second inner arc surface 112Bp of the second sub-pivot portion 112B may form an arc-shaped inner surface, and the arc-shaped inner surface is the first pivot surface 112p of the first pivot portion 112.

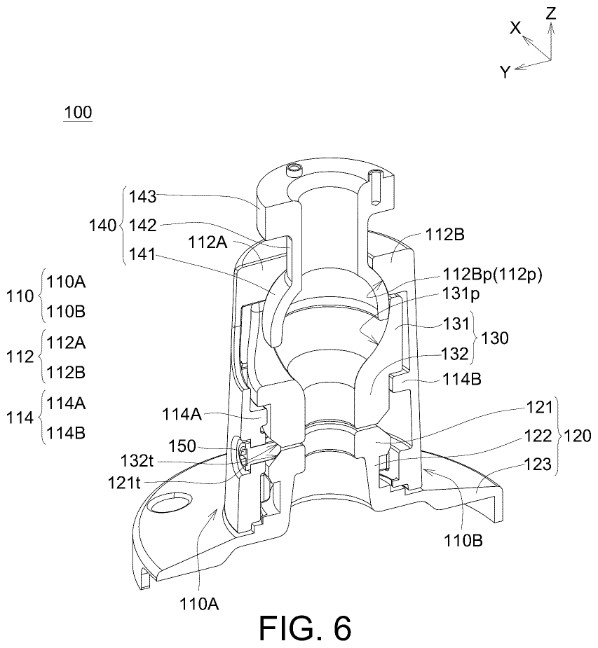

FIG. 6 is a schematic 3D cross-sectional view of the fixing structure 100 of FIG. 2.

Referring to FIGS. 1 and 6, the pushing member 130 may include a second pivot portion 131 and a third shaft portion 132. The second pivot portion 131 and the third shaft portion 132 can respectively be a tubular body. An outer diameter of the second pivot portion 131 is larger than an outer diameter of the third shaft portion 132, and the second pivot portion 131 has positioning grooves 131R. The positioning grooves 131R recess from a cross section of the Z-axis direction (XY plane) of the second pivot portion 131 along the Z-axis toward the third shaft portion 132.

Referring to FIGS. 4, 5 and 6, the first cover 110A and the second cover 110B may also include a first rib 114A and a second rib 114B, respectively. The first rib 114A and the second rib 114B are on the inner surfaces of the first cover body 111A and the second cover body 111B, respectively. While the first cover 110A and the second cover 110B are relatively fixed, the first rib 114A and the second rib 114B can connect to each other to form a rib 114 of the body 110. In addition, the first cover 110A and the second cover 110B may each include positioning blocks 115, which are on the rib 114 and extend along the Z-axis.

Please refer to FIGS. 1, 4, 5 and 6. The positioning grooves 131R can correspond to the positioning blocks 115. While the pushing member 130 is in the tubular space of the body 110, the third shaft portion 132 of the pushing member 130 passes through the rib 114, and the positioning blocks 115 can be in the positioning grooves 131R. The pushing member 130 is limited to move on the Z-axis by the positioning blocks 115 and the positioning grooves 131R. In addition, the second pivot portion 131 of the pushing member 130 can be on the rib 114 so that the pushing member 130 will not move in the negative direction of the Z-axis and out of the body 110.

Please refer to FIGS. 1, 2 and 3. While the pushing member 130 is in the tubular space of the body 110, a spherical space S can be between the first pivot portion 112 of the body 110 and the second pivot portion 131 of the pushing member 130. The arc-shaped body 141 of the adjustment member 140 is in the spherical space S between the first pivot portion 112 and the second pivot portion 131. The arc-shaped body 141 is in the Z-axis direction of the pushing member 130. The first pivot portion 112 is in the Z-axis direction of the arc-shaped body 141. Specifically, the second pivot portion 131 of the pushing member 130 can have a second pivot surface 131p, the arc-shaped body 141 is n the second pivot surface 131p, and the shape of the first pivot surface 112p can matches the arc-shape body 141, so that the arc-shaped body 141 can tightly attach to the first pivot surface 112p and the second pivot surface 131p.

Referring to FIGS. 1, 4 and 6, the locking member 150 is on the body 110. In the present embodiment, the first cover 110A of the body 110 may have a through hole H, and the through hole H may have a thread. The locking member 150 is on the body 110 and passes through the through hole H. An end 151 of the locking member 150 can extend into the interior of the body 110 through the through hole H. The locking member 150 can push against the base 120 and/or the pushing member 130, thereby allowing the first pivot portion 112 and the second pivot portion 131 to clamp or relax the arc-shaped body 141.

Referring to FIGS. 1 and 6, the base 120 may have a first surface 121t, and the first surface 121t may be tapered. The first surface 121t may be in the positive Z-axis direction of the protruding portion 121 of the base 120. The pushing member 130 may have a second surface 132t, and the second surface 132t may be tapered. The second surface 132t may be in the negative Z-axis direction of the third axis portion 132 of the pushing member 130. While the end 151 of the locking member 150 extends into the body 110, the end 151 can be substantially between the first surface 121t and the second surface 132t. The first surface 121t and the second surface 132t connect to form an annular groove (not labeled), and the end 151 of the locking member 150 can be a tapered surface that matches the groove. Therefore, if the locking member 150 moves in the negative direction of the Y-axis, the end 151 can push against the first surface 121t and the second surface 132t, driving the base 120 and the pushing member 130 to separate from each other, and the pushing member 130 moves toward the adjustment member 140, so that the arc-shaped body 141 is in a tight state between the first pivot portion 112 and the second pivot portion 131. If the locking member 150 moves in the positive direction of the Y-axis, the end 151 will be farther away from the first surface 121t and the second surface 132t, the pushing member 130 moves closer to the base 120 due to the influence of gravity, so that the arc-shaped body 141 is in a relaxed state relative to the first pivot portion 112 and the second pivot portion 131.

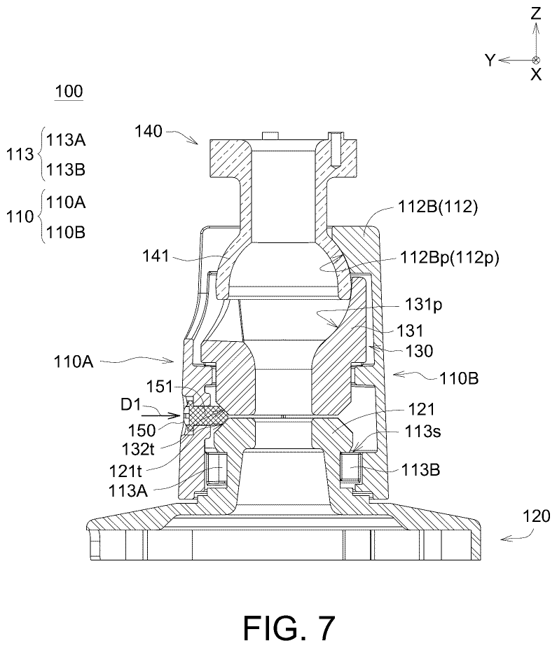

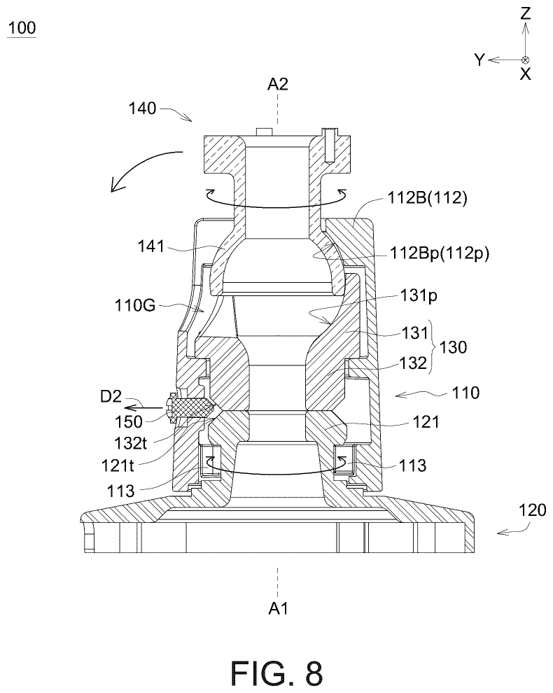

FIG. 7 is a schematic cross-sectional view of the fixing structure 100 taken along section line 7-7′ of FIG. 2, showing the arc-shaped body 141 in a tight state. FIG. 8 is a schematic cross-sectional view of the fixing structure 100, showing the arc-shaped body 141 in a relaxed state.

Referring to FIGS. 7 and 8, the locking member 150 can move in a locking direction D1 or an unlocking direction D2 while being locked to the body 110, so that the first pivot portion 112 and the second pivot portion 131 clamps or relaxes the arc body 141. The locking direction D1 and the unlocking direction D2 are both parallel to the Y-axis.

Please refer to FIG. 4, FIG. 5 and FIG. 7. The first cover body 110A and the second cover body 110B may respectively include first protrusions 113A and second protrusions 113B, and may be on the inner surfaces of the first cover body 111A and the second cover body 111A, respectively. While the first cover 110A and the second cover 110B are relatively fixed, the first protrusion 113A and the second protrusion 113B can mutually form a protrusion 113 of the body 110. The protruding portion 121 of the base 120 is on the protrusion 113. While the locking member 150 moves in the locking direction D1, the end 151 of the locking member 150 pushes against the first surface 121t of the base 120 and the second surface 132t of the pushing member 130, causing the protruding portion 121 of the base 120 pressing the upper surface 113s of the protrusion 113 in the negative direction of the Z-axis; and the pushing member 130 moves in the positive direction of the Z-axis, so that the arc-shaped body 141 is in a tight state relative to the first pivot portion 112 and the second pivot portion 131. That is, the first pivot portion 112 and the second pivot portion 131 clamp the arc-shaped body 141. At this time, the arc-shaped body 141 is tightly against the first pivot surface 112p of the first pivot portion 112 and the second pivot surface 131p of the second pivot portion 131, and the protruding portion 121 is tightly against the protrusion 113, so that the base 120, the pushing member 130 and the adjustment member 140 are fixed to the body 110.

Please refer to FIG. 8. If you want to adjust the rotation angle of the base 120 and the adjustment member 140 relative to the body 110, move the locking member 150 toward the unlocking direction D2. During the movement of the locking member 150 in the unlocking direction D2, the locking member 150 is away from the first surface 121t of the base 120 and the second surface 132t of the pushing member 130, and the pushing member 130 moves in the negative direction of the Z-axis approaching the base 120 due to the influence of gravity. The arc-shaped body 141 is in a relaxed state relative to the first pivot portion 112 and the second pivot portion 131. That is, the first pivot portion 112 and the second pivot portion 131 relax the arc-shaped body 141. At this time, there is a gap between the arc-shaped body 141 and the second pivot surface 131p of the second pivot portion 131, so that the protruding portion 121 has a margin of movement on the protrusion 113. In this way, the base 120 can rotate relative to the body 110 with the first rotation axis A1 as the rotation axis; and the arc-shaped body 141 can pivots between the first pivot portion 112 and the second pivot portion 131 to allow the adjustment member 140 being rotatable relative to the body 110 with a second rotation axis A2 as the rotation axis, and/or change the pitch angle relative to the body 110.

Please refer to FIGS. 2 and 3. The body 110 may have a slot 110G. The slot 110G and the positioning groove 131R correspond and communicate with the spherical space S. The arc-shaped body 141 of the adjustment member 140 is in the spherical space S, and the second connecting portion 143 is in the positioning groove 131R and the slot 110G through the second shaft portion 142 and is exposed on the body 110. The slot 110G has a width W, and the width W is smaller than the outer diameter of the arc-shaped body 141, so the adjustment member 140 will not separate from the body 110 in the positive direction of the Z-axis.

Referring to FIG. 8, the adjustment member 140 is in the first position. At this time, the first rotation axis A1 and the second rotation axis A2 are coaxial, the arc-shaped body 141 is in a relaxed state, and the pitch angle of the adjustment member 140 can be adjusted on the YZ plane between the first position and the second position of the slot 110G.

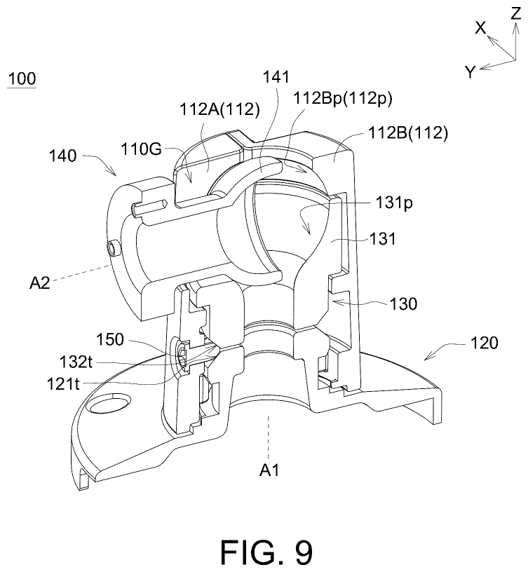

Please refer to FIG. 9, which is a schematic three-dimensional 3D cross-sectional view of the fixing structure 100, showing the adjustment member 140 in the second position. At this time, the first rotation axis A1 and the second rotation axis A2 intersect each other. After the adjustment of the rotation angle of the base 120 and the adjustment member 140 relative to the body 110 completes, the locking member 150 moves toward the locking direction D1 shown in FIG. 7, so that the arc-shaped body 141 is in a tight state to fix the rotation angle of the base 120 and the adjustment member 140 relative to the body 110.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An angle-adjustable fixing structure, comprising:
a body comprising a first pivot portion;
a base being on a side of the body;
a pushing member being on the base, the pushing member comprising a second pivot portion;
an adjustment member comprising an arc-shaped body, the arc-shaped body being between the first pivot portion and the second pivot portion; and
a locking member passing through the body.

2. The angle-adjustable fixing structure according to claim 1, wherein while the locking member pushes against the base and/or the pushing member, the first pivot portion and the second pivot portion clamp the arc-shaped body; while the locking member is away from the base and the pushing member, the first pivot portion and the second pivot portion relax the arc-shaped body.

3. The angle-adjustable fixing structure according to claim 1, wherein the base has a first surface, the pushing member has a second surface, the locking member comprises an end, and the end is between the first surface and the second surface and is in the body.

4. The angle-adjustable fixing structure according to claim 1, wherein, while the locking member pushes against the base and/or the pushing member, and the base, the pushing member and the adjustment member are fixed to the body.

5. The angle-adjustable fixing structure according to claim 1, wherein the base comprises a protruding portion, the body further comprises a protrusion, and the protruding portion is on the protrusion; while the locking member pushes against the base and/or the pushing member, the protruding portion presses the protrusion; while the locking member is away from the base and the pushing member, the base is rotatable relative to the body.

6. The angle-adjustable fixing structure according to claim 1, wherein, while the locking member is away from the base and the pushing member, the arc-shaped body is rotatably pivots between the first pivot portion and the second pivot portion.

7. The angle-adjustable fixing structure according to claim 1, wherein the body further comprises a slot, and the adjustment member is in the slot.

8. The angle-adjustable fixing structure according to claim 7, wherein a width of the slot is smaller than an outer diameter of the arc-shaped body.

9. The angle-adjustable fixing structure according to claim 7, wherein the base has a first rotation axis, and the adjustment member has a second rotation axis; while the adjustment member is in a first position, the first rotation axis and the second rotation axis are coaxial; while the adjustment member is in a second position, the first rotation axis and the second rotation axis intersect.

10. An angle-adjustable fixing structure, comprising:
a body comprising a first pivot portion;
a base comprising a first surface, the base being on a side of the body;
a pushing member comprising a second pivot portion and a second surface connecting to the first surface, and the pushing member being on the base;
an adjustment member comprising an arc-shaped body being between the first pivot portion and the second pivot portion; and
a locking member comprising an end, the locking member passing through the body, and the end being between the first surface and the second surface and being in the body.

11. The angle-adjustable fixing structure according to claim 10, wherein, while the locking member pushes against the base and/or the pushing member, the first pivot portion and the second pivot portion clamp the arc-shaped body; while the locking member is away from the base and the pushing member, the first pivot portion and the second pivot portion relax the arc-shaped body.

12. The angle-adjustable fixing structure according to claim 10, wherein the end has a tapered surface matching the first surface and the second surface.

13. The angle-adjustable fixing structure according to claim 10, wherein the base comprises a protruding portion, the body further comprises a protrusion, and the protruding portion is on the protrusion; while the locking member pushes the base and/or the pushing member, the protruding portion presses the protrusion; and/or while the locking member is away from the base and the pushing member, the base is rotatable relative to the body.

14. The angle-adjustable fixing structure according to claim 10, wherein the body further has a slot, and the adjustment member is in the slot; while the locking member is away from the base and the pushing member, an angle between a first position and a second position of the slot is adjustable by the adjustment member.

15. An angle-adjustable fixing structure, comprising:
a body comprising a first pivot portion and a slot;
a base being on a side of the body;
a pushing member being on the base, the pushing member comprising a second pivot portion;
an adjustment member being in the slot, the adjustment member comprising an arc-shaped body, and the arc-shaped body being between the first pivot portion and the second pivot portion; and
a locking member passing through the body.

16. The angle-adjustable fixing structure according to claim 15, wherein, while the locking member pushes against the base and/or the pushing member, the first pivot portion and the second pivot portion clamp the arc-shaped body; while the locking member is away from the base and the pushing member, the first pivot portion and the second pivot portion relax the arc-shaped body.

17. The angle-adjustable fixing structure according to claim 15, wherein the locking member comprises an end, and the end is between the base and the pushing member and in the body.

18. The angle-adjustable fixing structure according to claim 15, wherein, while the locking member pushes against the base and/or the pushing member, the base, the pushing member and the adjustment member are fixed to the body.

19. The angle-adjustable fixing structure according to claim 15, wherein the base comprises a protruding portion, the body further comprises a protrusion, and the protruding portion is on the protrusion; while the locking member pushes against the base and/or the pushing member, the protruding portion presses the protrusion; while the locking member is away from the base and the pushing member, the base is rotatable relative to the body.

20. The angle-adjustable fixing structure according to claim 15, wherein the base has a first rotation axis, and the adjustment member has a second rotation axis; while the adjustment member is in a first position, the first rotation axis and the second rotation axis are coaxial; and/or while the adjustment member is in a second position, the first rotation axis and the second rotation axis intersect.
